(19) United States
(12) Patent Application Publication
(10) Pub. No.: US 2025/0148358 A1
(43) Pub. Date: May 8, 2025

(54) TRAINING-FREE ARCHITECTURE SEARCH FOR EFFICIENT VISION TRANSFORMERS VIA APPROXIMATED ATTENTION STATISTICS

(71) Applicant: QUALCOMM Incorporated, San Diego, CA (US)

(72) Inventors: Zhuojin LI, Los Angeles, CA (US); Hsin-Pai CHENG, San Diego, CA (US); Hong CAI, San Diego, CA (US); Sweta PRIYADARSHI, San Diego, CA (US); Kartikeya BHARDWAJ, San Diego, CA (US); Viswanath GANAPATHY, Dublin, CA (US); Chirag Sureshbhai PATEL, San Diego, CA (US); Fatih Murat PORIKLI, San Diego, CA (US)

(21) Appl. No.: 18/504,117

(22) Filed: Nov. 7, 2023

(51) Int. Cl. G06N 20/00

(52) U.S. Cl. CPC G06N 20/00

(57) ABSTRACT

A processor-implemented method for training-free architecture searching for a transformer model includes generating a set of transformer model candidates for a target device. Each transformer model candidate of the set of transformer model candidates is initialized with random weights. A set of data samples are randomly sampled to produce random data samples for inputting at each transformer model candidate. An attention confidence score is computed for each transformer model candidate based on the random data samples and the random weights. A transformer model candidate for the target device is selected based on the attention confidence score.

### FIELD OF THE DISCLOSURE

Aspects of the present disclosure generally relate to machine learning, and more specifically to training-free architecture searching for efficient vision transformers.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed forward artificial neural network. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Edge devices such as smartphones are widely used. Given the many useful applications of neural networks, there is increasing demand for use of edge devices and for personalized services for such edge devices. However, edge devices have limited computational resources and generalized models may utilize more complex networks and computational resources.

Transformer-based architectures have become the de-facto standard models for a wide range of natural language processing tasks. However, their memory footprint and high latency are prohibitive for efficient deployment and inference on resource-limited devices.

Deploying a high-level neural network on embedded devices is difficult yet important for the widespread use of deep learning. One obstacle involves determining a suitable neural architecture for performing a task. Neural architecture search (NAS) is a subfield of automated machine learning for automating the design of artificial neural networks. NAS aims to determine the most suitable architecture for a neural network for a given task. NAS has been gaining popularity because finding the right neural network architecture for any use-case is a non-trivial task. Within the deep learning community, it is well known that exploring the various possible neural network architectures can take many months or even years. NAS may help substantially reduce the time needed to explore different architectures to days of compute time rather than months or years. NAS may also help to identify certain novel and complex architectures that may otherwise be undiscoverable. However, existing NAS and compression algorithms may be computationally expensive, heavily targeted at convolutional neural networks, or mismatch with hardware behavior.

Furthermore, the usefulness of NAS results may be limited according to the search space. NAS techniques may generally be employed when the search space is too big to explore manually. However, the excessive size of the search space makes the relationship between the NAS parameters and the NAS reward difficult to analyze later. As a result, it is challenging to effectively update the search space after a NAS.

### SUMMARY

The present disclosure is set forth in the independent claims, respectively. Some aspects of the disclosure are described in the dependent claims.

In some aspects of the present disclosure, a processor-implemented method performed by at least one processor includes generating a set of transformer model candidates for a target device. Each transformer model candidate of the set of transformer model candidates is initialized with random weights. The processor-implemented method also includes randomly sampling a set of data samples to produce random data samples for inputting at each transformer model candidate. The processor-implemented method further includes computing an attention confidence score for each transformer model candidate based on the random data samples and the random weights. The processor-implemented method further still includes selecting a transformer model candidate for the target device based on the attention confidence score.

Various aspects of the present disclosure are directed to an apparatus including means for generating a set of transformer model candidates for a target device. Each transformer model candidate of the set of transformer model candidates is initialized with random weights. The apparatus also includes means for randomly sampling a set of data samples to produce random data samples for inputting at each transformer model candidate. The apparatus additionally includes means for computing an attention confidence score for each transformer model candidate based on the random data samples and the random weights. The apparatus further includes means for selecting a transformer model candidate for the target device based on the attention confidence score.

In some aspects of the present disclosure, a non-transitory computer-readable medium with non-transitory program code recorded thereon is disclosed. The program code is executed by at least one processor and includes program code to generate a set of transformer model candidates for a target device. Each transformer model candidate of the set of transformer model candidates is initialized with random weights. The program code additionally includes program code to randomly sampling a set of data samples to produce random data samples for inputting at each transformer model candidate. The program code also includes program code to compute an attention confidence score for each transformer model candidate based on the random data samples and the random weights. The program code further includes program code to select a transformer model candidate for the target device based on the attention confidence score.

Various aspects of the present disclosure are directed to an apparatus having a memory and one or more processors coupled to the memory. The processor(s) is configured to generate a set of transformer model candidates for a target device. Each transformer model candidate of the set of transformer model candidates is initialized with random weights. The processor(s) is also configured to randomly sample a set of data samples to produce random data samples for inputting at each transformer model candidate. The processor(s) is additionally configured to includes means for compute an attention confidence score for each transformer model candidate based on the random data samples and the random weights. The processor(s) is further configured to select a transformer model candidate for the target device based on the attention confidence score.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIG. 3 is a block diagram illustrating an exemplary software architecture that may modularize artificial intelligence (AI) functions, in accordance with various aspects of the present disclosure.

FIGS. 4A and 4B are a block diagrams illustrating a conventional vision transformer and a conventional transformer encoder.

FIG. 4C is a high-level block diagram further illustrating the conventional transformer encoder of FIGS. 4A and 4B.

FIG. 5 is a block diagram illustrating an example pipeline for training-free architecture searching for transformer models using approximated attention statistics, in accordance with various aspects of the present disclosure.

FIG. 6 is a flow diagram illustrating a processor-implemented method for training-free architecture searching for transformer modules, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Recently, transformer architectures have shown improvement in language modeling and natural language processing (NLP) tasks. Based on the conventional transformer architectures such as (but not limited to) bi-directional encoder representations from transformers (BERT), robustly optimized BERT approach (RoBERTa), XLNet, Transformer-XL, and the generative pre-trained transformer (GPT) family of transformers (e.g., GPT-2, GPT-3, GPT-4, etc.), language models may be pre-trained with a large corpora of unlabeled text. Accordingly, such transformer architectures have become popular building blocks in conventional NLP pipelines, as well as in other areas such as computer vision and audio processing.

Vision transformers (ViTs) are widely used for computer vision tasks such as classification, detection, segmentation, and depth estimation, for example. Vision transformers apply transformer architectures directly to images. Rather than process tokens including portions (words) of text or audio sequences, vision transformers split an image into patches and treat the patches as tokens in an NLP application.

Despite providing performance improvements in many applications, pre-trained transformer-based models may be extremely large, sometimes exceeding billions of parameters, for example. Hence, efficient deployment of such transformer-based models on resource-constrained embedded systems including mobile devices (e.g., smartphones) and Internet of Things (IoT) devices, and even some systems in data centers, is challenging due to increased latency, energy consumption, and a prohibitively large memory footprint.

Moreover, the architecture design process for transformer models such as vision transformers may involve complicated mixes of convolution and transformer blocks. Because of the model complexity, designing such transformer models may involve significant model training costs (e.g., thousands of graphics processing unit (GPU) hours), which may be prohibitive.

Some conventional approaches attempt to tailor transformer models including vision transformers to target hardware using neural architecture search techniques. Neural architecture search (NAS) is the process of automatically determining one or more architectures for a neural network that yields a defined performance level for a given task.

Some conventional approaches utilizing NAS techniques may be training-based approaches and involve significant model training. Some other conventional approaches utilizing NAS techniques aim to provide training-free approaches. However, such approaches may involve models with pre-trained weights or rely on manual search space design and may use search space definition to generate models of a target size/compute. For instance, some conventional approaches use search space definitions to generate tiny, small, and base model variants. In other words, model size/compute may not be part of the objective/constraints in the optimization formulation, limiting flexibility of the search. In particular, a manually defined search space is used to satisfy model size or compute specifications. Furthermore, such conventional approaches may also involve a backward pass of the model, which may be time consuming.

Accordingly, to address these and other issues, aspects of the present disclosure are directed to training-free architecture searching for vision transformers and other language models. In various aspects, approximated attention statistics may be employed to search for vision transformers.

Particular aspects of the subject matter described in this disclosure can be implemented to realize one or more of the following potential advantages. In some examples, the described techniques (e.g., computing maximum attention values and approximating attention confidence based on random weights) may enable high variance and increased discriminative behavior in the attention map. Moreover, the described techniques may increase processing efficiency and power consumption for target devices (e.g., mobile devices), improved artificial intelligence (AI) processing capabilities, enhanced camera, and image processing features, and accelerated augmented reality or virtual reality (AR/VR) experiences. For autonomous vehicles and internet of things (IoT) devices, the described techniques may enhance the object detection and recognition capabilities of self-driving cars and day-to-day IoT devices, making such vehicles/IoT devices safer and more reliable. Furthermore, in the context of generative artificial intelligence (AI) or AI assistants, the described techniques may enable more sophisticated and realistic content creation, data augmentation, and creative applications across various domains.

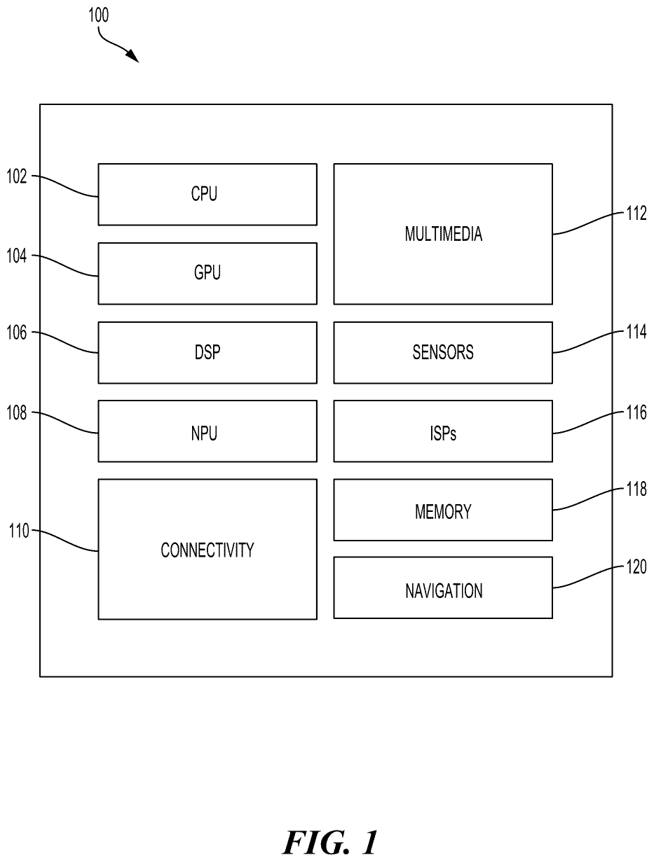

FIG. 1 illustrates an example implementation of a system-on-a-chip (SOC) 100, which may include a central processing unit (CPU) 102 or a multi-core CPU configured for architecture search for transformer models. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In aspects of the present disclosure, the instructions loaded into the general-purpose processor 102 may include code to generate a set of transformer model candidates for a target device. Each transformer model candidate of the set of transformer model candidates is initialized with random weights. The instructions loaded into the general-purpose processor 102 may also include code to randomly sample a set of data samples to produce random data samples for inputting at each transformer model candidate. The instructions loaded into the general-purpose processor 102 may additionally include code to compute an attention confidence score for each transformer model candidate based on the random data samples and the random weights. The instructions loaded into the general-purpose processor 102 may further include code to select a transformer model candidate for the target device based on the attention confidence score.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed forward networks, information is passed from lower to higher layers, with each neuron in a given layer communicating to neurons in higher layers. A hierarchical representation may be built up in successive layers of a feed forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

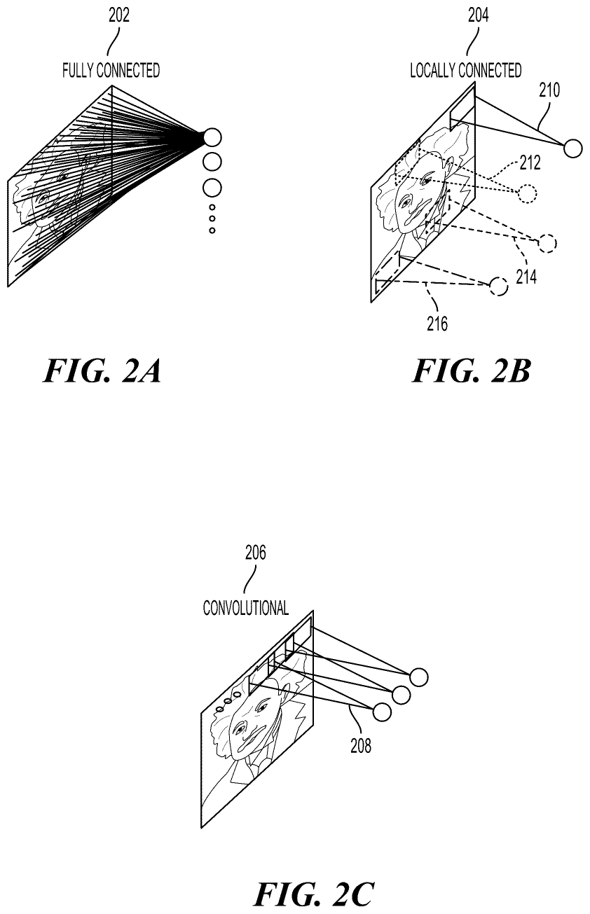

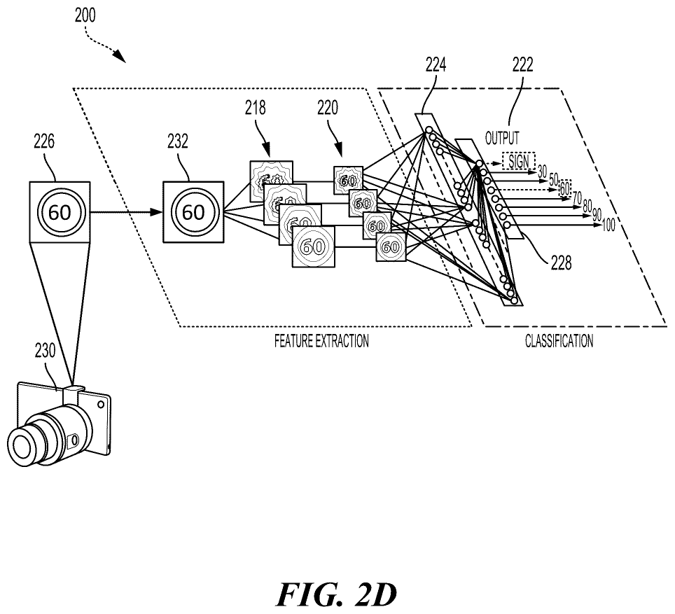

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolution kernels (not shown) to the image 226 to generate a first set of feature maps 218. As an example, the convolution kernel for the convolutional layer 232 may be a 5×5 kernel that generates 28×28 feature maps. In the present example, because four different feature maps are generated in the first set of feature maps 218, four different convolution kernels were applied to the image 226 at the convolutional layer 232. The convolution kernels may also be referred to as filters or convolution filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed forward networks. In addition, as described above, the connections from a neuron in a first layer of a DCN to a group of neurons in the next higher layer are shared across the neurons in the first layer. The feed forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

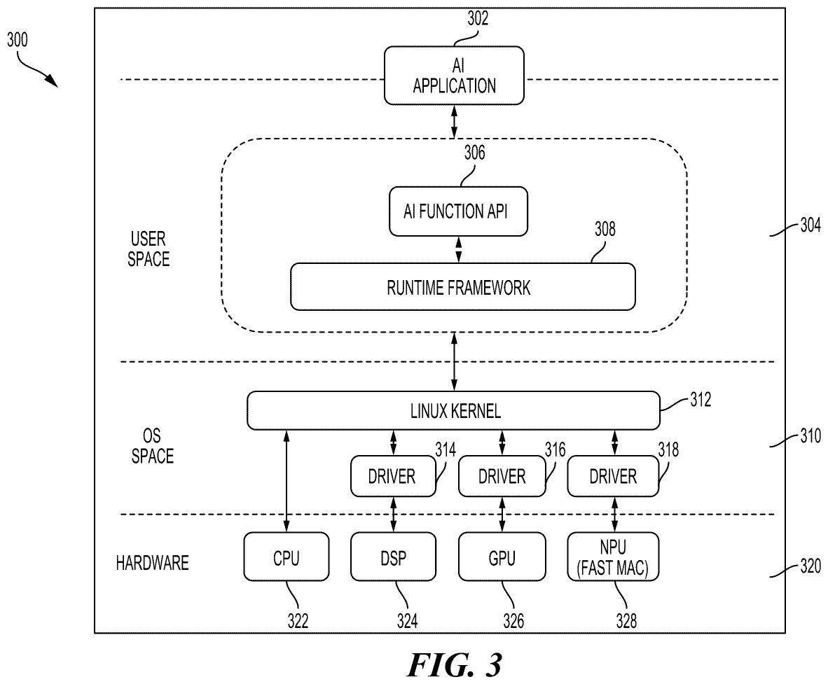

FIG. 3 is a block diagram illustrating an exemplary software architecture 300 that may modularize artificial intelligence (AI) functions. Using the architecture 300, applications may be designed that may cause various processing blocks of a system-on-a-chip (SoC) 320 (for example a CPU 322, a DSP 324, a GPU 326 and/or an NPU 328) (which may be similar to SOC 100 of FIG. 1) to support architecture search for transformer models for an AI application 302, according to aspects of the present disclosure. The architecture 300 may, for example, be included in a computational device, such as a smartphone.

The AI application 302 (e.g., an AI application) may be configured to call functions defined in a user space 304 that may, for example, provide for the detection and recognition of a scene indicative of the location at which the computational device including the architecture 300 currently operates. The AI application 302 may, for example, configure a microphone and a camera differently depending on whether the recognized scene is an office, a lecture hall, a restaurant, or an outdoor setting such as a lake. The AI application 302 may make a request to compiled program code associated with a library defined in an AI function application programming interface (API) 306. This request may ultimately rely on the output of a deep neural network configured to provide an inference response based on video and positioning data, for example.

A run-time engine 308, which may be compiled code of a runtime framework, may be further accessible to the AI application 302. The AI application 302 may cause the run-time engine 308, for example, to request an inference at a particular time interval or triggered by an event detected by the user interface of the AI application 302. When caused to provide an inference response, the run-time engine 308 may in turn send a signal to an operating system in an operating system (OS) space, such as a Linux Kernel 312, running on the SoC 320. The operating system, in turn, may cause a continuous relaxation of quantization to be performed on the CPU 322, the DSP 324, the GPU 326, the NPU 328, or some combination thereof. The CPU 322 may be accessed directly by the operating system, and other processing blocks may be accessed through a driver, such as a driver 314, 316, or 318 for, respectively, the DSP 324, the GPU 326, or the NPU 328. In the exemplary example, the deep neural network may be configured to run on a combination of processing blocks, such as the CPU 322, the DSP 324, and the GPU 326, or may be run on the NPU 328.

As described, aspects of the present disclosure are directed to training-free architecture searching for vision transformers and other language models. For each intermediate vision transformer model, during the search, weights of the model may be randomly initialized. In doing so, a general response of the model to inputs may be captured and maximum attention values of the model may be computed. By using the maximum attention values, active attention weights may be employed to facilitate more clear discriminative outputs from following softmax operations of the model.

The model may also be evaluated using attention confidence. Attention confidence is an evaluation technique that aims to determine the more important attention heads in the model. Attention confidence may provide a score function for pruning a transformer model. The confidence of an attention head may be considered the average of its maximum attention weight, where the average may be taken over tokens (or patches for vision transformers) in a set of sentences.

The attention confidence of a transformer may be given by:

$$Attention Confidence = \frac{1}{N} {\sum }_{i = 1}^{N} {\sum }_{h = 1}^{H} \vert max ( A t {t}_{h} ( {x}_{i} ) ) \vert , \qquad ( 1 )$$

where H represents the number attention blocks, Attₕ is the attention weight for an attention block, N represents the number of inputs, xᵢ represents a minibatch of input data (e.g., CIFAR-10, CIFAR-100, or ImageNet datasets) and i is an index for the input data. The attention confidence can be averaged over random inputs and random weights, to capture summary statistics of the candidate architecture. That is unlike conventional approaches that utilize a pre-trained model (e.g., trained weights). The attention confidence may be approximated using the average over random inputs and random weights. These approximated attention statistics may then be employed to search for vision transformers. Additional attention statistics may also be employed to capture various statistical properties of the attention response. For example, attention variance may further capture the diversity of the attention response. The attention variance may be given by:

$$Attention Variance = \frac{1}{N} {\sum }_{i = 1}^{N} {\sum }_{h = 1}^{H} var ( At {t}_{h} ( {x}_{i} ) ) , \qquad ( 2 )$$

where var represents the variance function. The variance function may refer to a function that measures dispersion (e.g., how far spread out from the average value) and may correspond to the expected value of the squared deviation from the mean of a random variable. A high variance may indicate more discriminative behavior in the attention map, as compared to all large values, for instance. In some aspects, a small amount of randomly sampled images (e.g., may be in the range of 56-256 randomly sampled images) may be employed to calculate an attention confidence score. By utilizing random samples, it is possible to sample more diverse images, for example, using image similarity metrics such as structural similarity (SSIM) or feature similarity based on pretrained backbones like residual networks (ResNets), for instance.

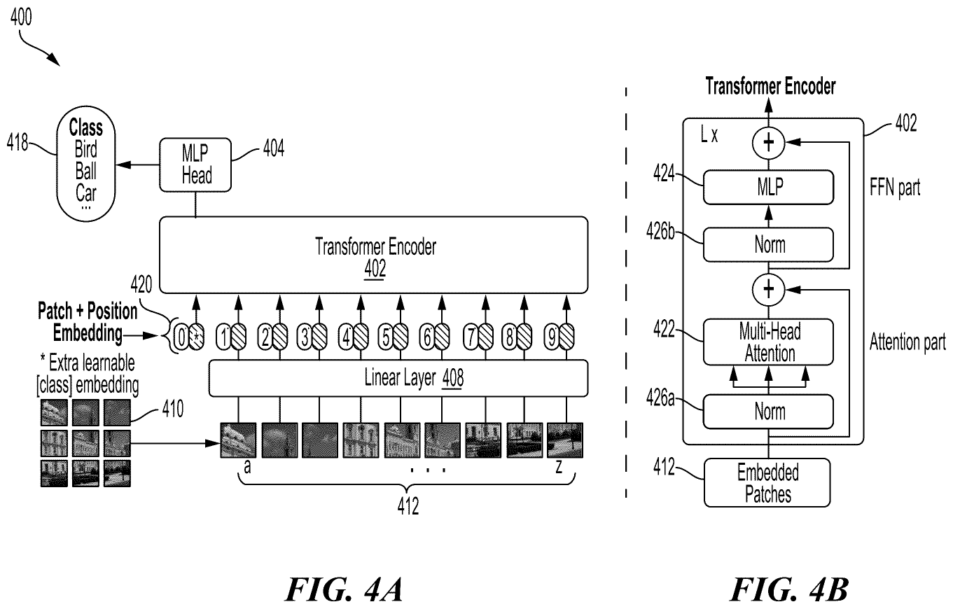

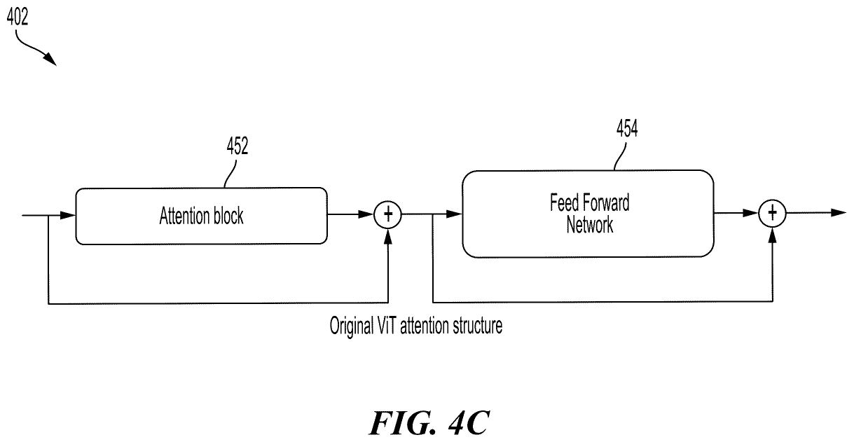

FIGS. 4A and 4B are a block diagrams illustrating a conventional vision transformer 400 and a conventional transformer encoder 402. Referring to FIG. 4A, the conventional vision transformer 400 includes the conventional transformer encoder 402 and a multilayer perceptron (MLP) head 404.

The conventional vision transformer 400 may operate in a manner similar to transformers in natural language processing applications. That is, the conventional vision transformer 400 may split an input image 410 (shown split into patches of pixels) into multiple patches 412a-z (collectively referred to as image patches 412) that may be treated as tokens (e.g., words). The image patches 412 are supplied to a linear layer 408, which generates a sequence of linear embeddings. Positional embeddings may be added to the linear embeddings to form patch and positional embeddings 420, which may be provided to the conventional transformer encoder 402.

The conventional transformer encoder 402 processes the patch and positional embeddings 420 to determine relationships between the patch and positional embeddings 420 and generates an output. The output is provided to the MLP head 404, which generates a classification 418 for the input image 410.

FIG. 4B shows an expanded view of the conventional transformer encoder 402. The conventional transformer encoder 402 includes alternating layers of multi-head attention blocks 422 and MLP blocks 424. A layer norm block 426 (e.g., 426a, 426b) may be applied before every block of the conventional transformer encoder 402. The multi-head attention blocks 422 and MLP blocks 424 may each include a residual connection.

FIG. 4C is a high-level block diagram further illustrating the conventional transformer encoder 402 of FIGS. 4A and 4B. The conventional transformer encoder 402 may be considered as having an alternating block structure including an attention block 452 and a feed forward network block 454. The attention block 452 and the feed forward network block 454 each have residual connections. The attention block 452 includes the multi-head attention block 422 shown in FIG. 4B. The feed forward network block 454 includes the MLP block 424, also shown in FIG. 4B.

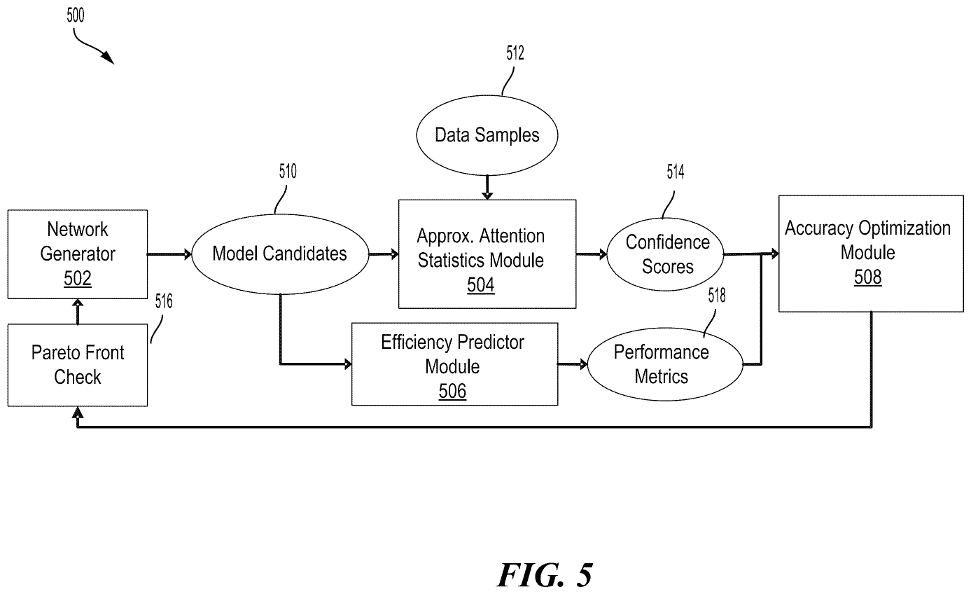

FIG. 5 is a block diagram illustrating an example pipeline 500 for training-free architecture searching for transformer models using approximated attention statistics, in accordance with various aspects of the present disclosure. Referring to FIG. 5, the example pipeline 500 includes a network generator 502, an approximated attention statistics module 504, an efficiency predictor module 506, and an accuracy optimization module 508. The network generator 502 may generate multiple model architectures (e.g., but not limited to 1000 model architectures) for target hardware. The target hardware may, for instance, comprise (but is not limited to) a mobile device such as a smartphone, an IoT device, an autonomous vehicle, a virtual reality (VR) device, SOC 100, or a component thereof such as CPU 102, GPU 104, DSP 106, or NPU 108 or other devices.

The model architectures may be (but are not limited to) transformer models such as a language model or a vision transformer (e.g., 400 of FIG. 4A). The model architectures may be parsed to determine a set of model candidates 510. The weights of each of the model candidates 510 may be randomly initialized.

The approximated attention statistics module 504 may receive a set of data samples 512 as an input. The data samples 512 may comprise (but are not limited to) images, textual data, or audio data, for example. The data samples 512 may be input into the model candidates 510 and processed in a forward pass of each model candidate 510. The approximated attention statistics module 504 may compute the approximation of the attention confidence to capture summary statistics of the architectures of the model candidates 510 and/or other attention statistics (e.g., variance) estimated based on random weights and data samples (e.g., according to Equation 1 using an average based on the random inputs and random weights) for the target hardware. The approximated attention statistics module 504 may output confidence scores 514 for each of the model candidates 510.

The efficiency predictor module 506 may evaluate the performance of each of the model candidates 510 on certain hardware devices. For instance, performance metrics 518 including, but are not limited to, latency results (e.g., measured in floating point operations per second (FLOPS)), power consumption, or other performance metrics 518 may be collected by the efficiency predictor module 506. The accuracy optimization module 508 may receive the confidence score and performance metrics and may apply one or more thresholds. In some aspects, the accuracy optimization module 508 may also receive other attention statistics (e.g., variance) as well as design parameters such as efficiency budgets. By incorporating efficiency into optimization, aspects of the present disclosure may beneficially increase flexibility of the architecture search. For instance, a larger, more flexible search space may be employed and may be optimized in an automated approach. As a result, deployment on-target (e.g., deployment on-target may refer to operating the model directly on specific hardware (e.g., CPU 102, GPU 104, DSP 106, or NPU 108)) may be more feasible when real on-target latency is measured during search.

The accuracy optimization module 508 may determine whether the confidence scores 514 and performance metrics 518 exceed (or fall below) the thresholds. The accuracy optimization module 508 may output the confidence scores 514, performance metrics 518, and threshold comparison information to a Pareto front check module 516.

The Pareto front check module 516 may compute a Pareto front for the model candidates 510. A Pareto front may be a set of feasible decisions in a metric space (e.g., the search space of model candidates 510). Then, using the criteria given by the applied thresholds of the accuracy optimization module 508, an evolutionary search process may be conducted to prune model candidates 510 that exceed certain performance metrics (e.g., accuracy inference time) and select a model candidate for use on target hardware.

The process implemented via the example pipeline 500 may be repeated to further refine the selection of a model candidate 510 for the target hardware. In some aspects with each iteration of the process implemented via the pipeline 500, the Pareto front check module 516 may determine a change in the Pareto front. The process may end when the change on the Pareto front is less than a predefined threshold.

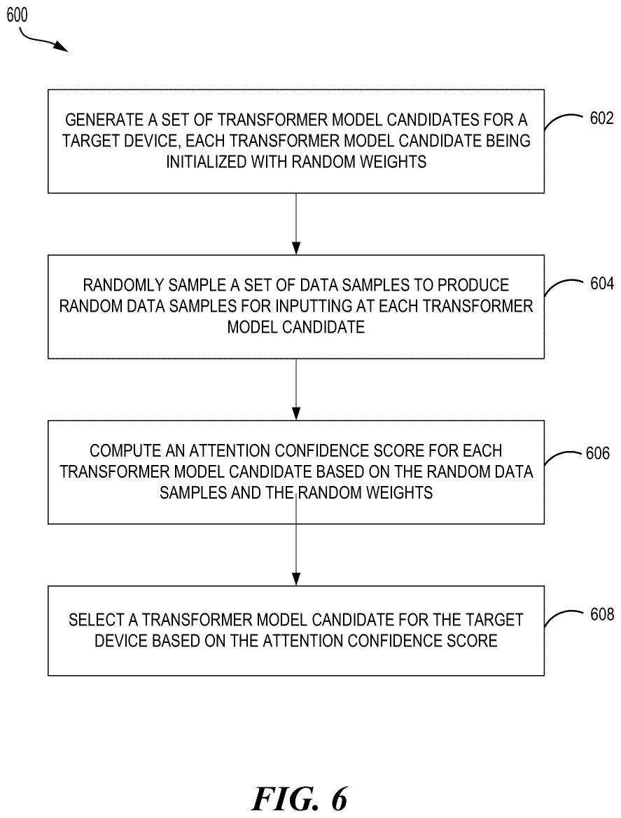

FIG. 6 is a flow diagram illustrating a processor-implemented method 600 for training-free architecture searching for transformer modules, in accordance with various aspects of the present disclosure. The processor-implemented method 600 may be performed by one or more processors such as the CPU (e.g., 102, 322), the GPU (e.g., 104, 326), DSP (e.g., 106, 324) or NPU (e.g., 108, 328) and/or other processing units, for example.

As shown in FIG. 6, at block 602, the one or more processors generates a set of transformer model candidates for a target device. Each transformer model candidate of the set of transformer model candidates may be initialized with random weights. For instance, as described with reference to FIG. 5, the network generator 502 may generate multiple model architectures (e.g., but not limited to 1000 model architectures) for target hardware. The target hardware may, for instance, comprise (but is not limited to) a mobile device such as a smartphone, an IoT device, an autonomous vehicle, a virtual reality (VR) device, SOC 100, or a component thereof such as CPU 102, GPU 104, DSP 106, or NPU 108 or other devices. The weights of each of the model candidates 510 may be randomly initialized.

At block 604, the one or more processors randomly sampling a set of data samples to produce random data samples for inputting at each transformer model candidate. As described, for example, with reference to FIG. 5, the approximated attention statistics module 504 may receive a set of data samples 512 as an input. The data samples 512 may comprise (but are not limited to) images, textual data, or audio data, for example.

At block 606, the one or more processors compute an attention confidence score for each transformer model candidate based on the random data samples and the random weights. For instance, as described with reference to FIG. 5, the data samples 512 may be input into the model candidates 510 and processed in a forward pass of each model candidate 510, the approximated attention statistics module 504 may compute the approximation of the attention confidence to capture summary statistics of the architectures of the model candidates 510 and/or other attention statistics (e.g., variance) estimated based on random weights and data samples (e.g., according to Equation 1 using an average based on the random inputs and random weights) for the target hardware.

At block 608, the one or more processors select a transformer model candidate for the target device based on the attention confidence score. As described, for example, with reference to FIG. 5, the Pareto front check module 516 may compute a Pareto front for the model candidates 510. Then, using the criteria given by the applied thresholds of the accuracy optimization module 508, an evolutionary search process may be conducted to prune model candidates 510 that exceed certain performance metrics (e.g., accuracy inference time) and select a model candidate for use on target hardware.

Implementation examples are provided in the following numbered clauses.
1. An apparatus comprising:
   at least one memory; and
   at least one processor coupled to the at least one memory, the at least one processor configured to:
   generate a set of transformer model candidates for a target device, each transformer model candidate of the set of transformer model candidates being initialized with random weights;
   randomly sample a set of data samples to produce random data samples for inputting at each transformer model candidate;
   compute an attention confidence score for each transformer model candidate based on the random data samples and the random weights; and
   select a transformer model candidate for the target device based on the attention confidence score.
2. The apparatus of clause 1, in which the at least one processor is further configured to:
process the random data samples using each transformer model candidate; and
determine one or more performance metric for each transformer model candidate, in which the transformer model candidate is selected based on the one or more performance metric for each transformer model candidate.
3. The apparatus of clause 1 or 2, in which the one or more performance metric is compared to one or more threshold and the transformer model candidate is selected based on the comparing.
4. The apparatus of any of clauses 1-3, in which the at least one processor is further configured to compute the attention confidence score as an average of a maximum attention weight based on the random weights and the random data samples.
5. The apparatus of any of clauses 1-4, in which the at least one processor is further configured to select the transformer model candidate based on an attention variance for each transformer model candidate.
6. The apparatus of any of clauses 1-5, in which the random data samples comprise images that are not artificially generated to include random pixel values.
7. The apparatus of any of clauses 1-6, in which the selected transformer model candidate comprises a vision transformer or a language model.
8. A processor-implemented method performed by at least one processor, the processor-implemented method comprising:
generating a set of transformer model candidates for a target device, each transformer model candidate of the set of transformer model candidates being initialized with random weights;
randomly sampling a set of data samples to produce random data samples for inputting at each transformer model candidate;
computing an attention confidence score for each transformer model candidate based on the random data samples and the random weights; and
selecting a transformer model candidate for the target device based on the attention confidence score.
9. The processor-implemented method of clause 8, further comprising:
processing the random data samples using each transformer model candidate; and
determining one or more performance metric for each transformer model candidate, in which the transformer model candidate is selected based on the one or more performance metric for each transformer model candidate.
10. The processor-implemented method of clause 8 or 9, in which the one or more performance metric is compared to one or more threshold and the transformer model candidate is selected based on the comparing.
11. The processor-implemented method of any of clauses 8-10, in which the attention confidence score is computed as an average of a maximum attention weight based on the random weights and the random data samples.
12. The processor-implemented method of any of clauses 8-11, in which the transformer model candidate is selected based on an attention variance for each transformer model candidate.
13. The processor-implemented method of any of clauses 8-12, in which the random data samples comprise images that are not artificially generated to include random pixel values.
14. The processor-implemented method of any of clauses 8-13, in which the selected transformer model candidate comprises a vision transformer or a language model.
15. A non-transitory computer-readable medium having program code recorded thereon, the program code executed by a processor and comprising:
program code to generate a set of transformer model candidates for a target device, each transformer model candidate of the set of transformer model candidates being initialized with random weights;
program code to randomly sample a set of data samples to produce random data samples for inputting at each transformer model candidate;
program code to compute an attention confidence score for each transformer model candidate based on the random data samples and the random weights; and
program code to select a transformer model candidate for the target device based on the attention confidence score.
16. The non-transitory computer-readable medium of clause 15, in which the program code comprises:
program code to process the random data samples using each transformer model candidate; and
program code to determine one or more performance metric for each transformer model candidate, in which the transformer model candidate is selected based on the one or more performance metric for each transformer model candidate.
17. The non-transitory computer-readable medium of clause 15 or 16, in which the program code comprises:
program code to compare the one or more performance metric to one or more threshold; and
program code to select the transformer model candidate based on the comparing.
18. The non-transitory computer-readable medium of any of clauses 15-17, in which the program code comprises program code to compute the attention confidence score as an average of a maximum attention weight based on the random weights and the random data samples.
19. The non-transitory computer-readable medium of any of clauses 15-18, in which the program code comprises program code to select the transformer model candidate based on an attention variance for each transformer model candidate.
20. The non-transitory computer-readable medium of any of clauses 15-19, in which the random data samples comprise images that are not artificially generated to include random pixel values.
21. The non-transitory computer-readable medium of any of clauses 15-20, in which the selected transformer model candidate comprises a vision transformer or a language model.
22. An apparatus comprising:
means for generating a set of transformer model candidates for a target device, each transformer model candidate of the set of transformer model candidates being initialized with random weights;
means for randomly sampling a set of data samples to produce random data samples for inputting at each transformer model candidate;
means for computing an attention confidence score for each transformer model candidate based on the random data samples and the random weights; and
means for selecting a transformer model candidate for the target device based on the attention confidence score.
23. The apparatus of clause 22, further comprising:
means for processing the random data samples using each transformer model candidate; and
means for determining one or more performance metric for each transformer model candidate, in which the transformer model candidate is selected based on the one or more performance metric for each transformer model candidate.
24. The apparatus of clause 22 or 23, further comprising:
means for comparing the one or more performance metric to one or more threshold; and
means for selecting the transformer model candidate based on the comparing.
25. The apparatus of any of clauses 22-24, further comprising means for computing the attention confidence score as an average of a maximum attention weight based on the random weights and the random data samples.
26. The apparatus of any of clauses 22-25, further comprising means for selecting the transformer model candidate based on an attention variance for each transformer model candidate.
27. The apparatus of any of clauses 22-26, in which the random data samples comprise images that are not artificially generated to include random pixel values.
28. The apparatus of any of clauses 22-27, in which the selected transformer model candidate comprises a vision transformer or a language model.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus comprising:
at least one memory; and
at least one processor coupled to the at least one memory, the at least one processor configured to:
generate a set of transformer model candidates for a target device, each transformer model candidate of the set of transformer model candidates being initialized with random weights;
randomly sample a set of data samples to produce random data samples for inputting at each transformer model candidate;
compute an attention confidence score for each transformer model candidate based on the random data samples and the random weights; and
select a transformer model candidate for the target device based on the attention confidence score.

2. The apparatus of claim 1, in which the at least one processor is further configured to:
process the random data samples using each transformer model candidate; and
determine one or more performance metric for each transformer model candidate, in which the transformer model candidate is selected based on the one or more performance metric for each transformer model candidate.

3. The apparatus of claim 2, in which the one or more performance metric is compared to one or more threshold and the transformer model candidate is selected based on the comparing.

4. The apparatus of claim 1, in which the at least one processor is further configured to compute the attention confidence score as an average of a maximum attention weight based on the random weights and the random data samples.

5. The apparatus of claim 1, in which the at least one processor is further configured to select the transformer model candidate based on an attention variance for each transformer model candidate.

6. The apparatus of claim 1, in which the random data samples comprise images that are not artificially generated to include random pixel values.

7. The apparatus of claim 1, in which the selected transformer model candidate comprises a vision transformer or a language model.

8. A processor-implemented method performed by at least one processor, the processor-implemented method comprising:
generating a set of transformer model candidates for a target device, each transformer model candidate of the set of transformer model candidates being initialized with random weights;
randomly sampling a set of data samples to produce random data samples for inputting at each transformer model candidate;
computing an attention confidence score for each transformer model candidate based on the random data samples and the random weights; and
selecting a transformer model candidate for the target device based on the attention confidence score.

9. The processor-implemented method of claim 8, further comprising:
processing the random data samples using each transformer model candidate; and
determining one or more performance metric for each transformer model candidate, in which the transformer model candidate is selected based on the one or more performance metric for each transformer model candidate.

10. The processor-implemented method of claim 9, in which the one or more performance metric is compared to one or more threshold and the transformer model candidate is selected based on the comparing.

11. The processor-implemented method of claim 8, in which the attention confidence score is computed as an average of a maximum attention weight based on the random weights and the random data samples.

12. The processor-implemented method of claim 8, in which the transformer model candidate is selected based on an attention variance for each transformer model candidate.

13. The processor-implemented method of claim 8, in which the random data samples comprise images that are not artificially generated to include random pixel values.

14. The processor-implemented method of claim 8, in which the selected transformer model candidate comprises a vision transformer or a language model.

15. A non-transitory computer-readable medium having program code recorded thereon, the program code executed by a processor and comprising:
program code to generate a set of transformer model candidates for a target device, each transformer model candidate of the set of transformer model candidates being initialized with random weights;
program code to randomly sample a set of data samples to produce random data samples for inputting at each transformer model candidate;
program code to compute an attention confidence score for each transformer model candidate based on the random data samples and the random weights; and
program code to select a transformer model candidate for the target device based on the attention confidence score.

16. The non-transitory computer-readable medium of claim 15, in which the program code comprises:
program code to process the random data samples using each transformer model candidate; and
program code to determine one or more performance metric for each transformer model candidate, in which the transformer model candidate is selected based on the one or more performance metric for each transformer model candidate.

17. The non-transitory computer-readable medium of claim 16, in which the program code comprises:
program code to compare the one or more performance metric to one or more threshold; and
program code to select the transformer model candidate based on the comparing.

18. The non-transitory computer-readable medium of claim 15, in which the program code comprises program code to compute the attention confidence score as an average of a maximum attention weight based on the random weights and the random data samples.

19. The non-transitory computer-readable medium of claim 15, in which the program code comprises program code to select the transformer model candidate based on an attention variance for each transformer model candidate.

20. The non-transitory computer-readable medium of claim 15, in which the random data samples comprise images that are not artificially generated to include random pixel values.

21. The non-transitory computer-readable medium of claim 15, in which the selected transformer model candidate comprises a vision transformer or a language model.

22. An apparatus comprising:
means for generating a set of transformer model candidates for a target device, each transformer model candidate of the set of transformer model candidates being initialized with random weights;
means for randomly sampling a set of data samples to produce random data samples for inputting at each transformer model candidate;
means for computing an attention confidence score for each transformer model candidate based on the random data samples and the random weights; and
means for selecting a transformer model candidate for the target device based on the attention confidence score.

23. The apparatus of claim 22, further comprising:
means for processing the random data samples using each transformer model candidate; and
means for determining one or more performance metric for each transformer model candidate, in which the transformer model candidate is selected based on the one or more performance metric for each transformer model candidate.

24. The apparatus of claim 23, further comprising:
means for comparing the one or more performance metric to one or more threshold; and
means for selecting the transformer model candidate based on the comparing.

25. The apparatus of claim 22, further comprising means for computing the attention confidence score as an average of a maximum attention weight based on the random weights and the random data samples.

26. The apparatus of claim 22, further comprising means for selecting the transformer model candidate based on an attention variance for each transformer model candidate.

27. The apparatus of claim 22, in which the random data samples comprise images that are not artificially generated to include random pixel values.

28. The apparatus of claim 22, in which the selected transformer model candidate comprises a vision transformer or a language model.
